(19) United States
(12) Patent Application Publication
(10) Pub. No.: US 2022/0059246 A1
(43) Pub. Date: Feb. 24, 2022

(54) CONTROL DRUM ASSEMBLY AND ASSOCIATED NUCLEAR REACTORS AND METHODS

(71) Applicant: Battelle Energy Alliance, LLC, Idaho Falls, ID (US)

(72) Inventor: Anthony L. Crawford, Rigby, ID (US)

(21) Appl. No.: 17/399,894

(22) Filed: Aug. 11, 2021

Related U.S. Application Data
(60) Provisional application No. 63/066,977, filed on Aug. 18, 2020.

(51) Int. Cl. G21C 7/10

(52) U.S. Cl. CPC G21C 7/10

(57) ABSTRACT

A control drum assembly may include a control drum and a control assembly coupled to the control drum through a drive shaft. The control drum assembly may also include a cage assembly. The cage assembly may include one or more structural supports and one or more modular platforms coupled to the one or more structural supports. The one or more modular platforms may be configured to support one or more components of the control assembly. The cage assembly may also include a base configured to be coupled to a surface of a core and to locate the cage assembly relative to the core.

### CROSS-REFERENCE TO RELATED APPLICATION

This application claims the benefit under 35 U.S.C. § 119(e) of U.S. Provisional Patent Application Ser. No. 63/066,977, filed Aug. 18, 2020, pending, the disclosure of which is hereby incorporated in its entirety herein by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

Embodiments of the present disclosure generally relate to control drum assemblies. In particular, embodiments of the present disclosure relate to control drum assemblies associated with nuclear energy production devices and associated components, systems, and methods.

### BACKGROUND

Some energy production devices harness heat by capturing, storing, or converting the heat to another form of energy, such as electrical energy. The heat may be produced through burning processes, such as coal fire power plants, or by heat generated by a reactor, such as a nuclear reactor. Nuclear reactors contain and control nuclear chain reactions that produce heat through a physical process called fission, where a particle (e.g., a neutron) is fired at an atom, which then splits into two smaller atoms and some additional neutrons. Some of the released neutrons then collide with other atoms, causing them to also fission and release more neutrons. A nuclear reactor achieves criticality (commonly referred to in the art as going critical) when each fission event releases a sufficient number of neutrons to sustain an ongoing series of reactions. Fission also releases a large amount of heat. The heat is removed from the reactor by a circulating fluid. This heat can then be used to produce electricity or can be harnessed and stored for uses, such as heating a facility or heating water.

Controlling the number of neutrons moving within a fuel chamber of the nuclear reactor may enable the system to control a size or intensity of the resulting reaction or heat generated by the chain reactions. Generally, the reaction is controlled by changing a proximity of an item including a neutron absorbing material (e.g., neutron poison, nuclear poison, neutron absorber), such as boron, cadmium, silver, hafnium, or indium, that are capable of absorbing many neutrons. The proximity of the neutron absorbing material may be controlled by a control rod that may be inserted into the fuel chamber or by a control drum that may have the neutron absorbing material present on one radial side of the drum, such that the drum may be rotated to adjust the proximity of the neutron absorbing material.

Generally, a nuclear energy production device will be designed such that there is sufficient neutron absorbing material present in the control rod or control drum to absorb all of the neutrons in the fuel chamber. This may enable the reaction to be entirely stopped by the control rod or control drum, such as for taking the nuclear energy production device offline, stopping an out of control reaction, or initiating an emergency shutdown.

### BRIEF SUMMARY

Some embodiments of the present disclosure may include a control drum assembly. The control drum assembly may include a control drum. The control drum assembly may further include a control assembly coupled to the control drum through a drive shaft. The control drum assembly may also include a cage assembly. The cage assembly may include one or more structural supports and one or more modular platforms coupled to the one or more structural supports. The one or more modular platforms may be configured to support one or more components of the control assembly.

Another embodiment of the present disclosure may include a nuclear reactor. The nuclear reactor may include a core and a control drum positioned within the core. The nuclear reactor may further include a control assembly coupled to the control drum through a drive shaft. The nuclear reactor may also include a cage assembly supporting the control assembly. The cage assembly may include a base. The base may include at least one platform configured to be coupled to a surface of the core. The at least one platform may include a protrusion configured to locate the cage assembly relative to the core.

Another embodiment of the present disclosure may include a method of returning a control drum to a fail-safe position. The method may include releasing a control drum from an angular position that is substantially different from a fail-safe angular position. The method may further include lowering the control drum through a threaded interface, configured to cause the control drum to rotate as the control drum is lowered. The method may also include stopping the control drum through a stop collar coupled to the control drum. The stop collar may be configured to stop a downward motion of the control drum at a position when the control drum is in the fail-safe angular position.

### BRIEF DESCRIPTION OF THE DRAWINGS

While the specification concludes with claims particularly pointing out and distinctly claiming embodiments of the present disclosure, the advantages of embodiments of the disclosure may be more readily ascertained from the following description of embodiments of the disclosure when read in conjunction with the accompanying drawings in which:

FIGS. 1 and 2 illustrate cross-sectional views of a core of an energy production device in accordance with embodiments of the present disclosure;

FIG. 3 illustrates a control drum assembly in accordance with embodiments of the present disclosure;

FIG. 4 illustrates a control assembly associated with the control drum assembly illustrated in FIG. 3;

FIG. 5 illustrates an embodiment of a clutch associated with the control assembly illustrated in FIG. 4;

FIG. 6 illustrates an embodiment of a binary sensor associated with the control assembly illustrated in FIG. 4;

FIGS. 7A and 7B illustrate different perspective views of a trigger associated with the binary sensor illustrated in FIG. 6;

FIG. 8 illustrates an embodiment of an analog sensor associated with the control assembly illustrated in FIG. 4;

FIG. 9 illustrates an embodiment of a damping device associated with the control assembly illustrated in FIG. 4;

FIGS. 10 and 11 illustrate different embodiments of a spring device associated with the control assembly illustrated in FIG. 4;

FIG. 12 illustrates a perspective view of a base assembly of the control assembly illustrated in FIG. 4;

FIG. 13 illustrates a cross-sectional view of the base assembly illustrated in FIG. 12;

FIGS. 14A and 14B illustrate a locating feature of the control drum assembly illustrated in FIG. 3;

FIG. 15 illustrates a plot of a response curve of the control drum assembly illustrated in FIG. 3; and

FIG. 16 is schematic diagram of a controller of a control drum assembly according to one or more embodiments of the present disclosure.

### DETAILED DESCRIPTION

The illustrations presented herein are not meant to be actual views of any particular energy production device or component thereof, but are merely idealized representations employed to describe illustrative embodiments. The drawings are not necessarily to scale.

As used herein, the term “substantially” in reference to a given parameter means and includes to a degree that one skilled in the art would understand that the given parameter, property, or condition is met with a small degree of variance, such as within acceptable manufacturing tolerances. For example, a parameter that is substantially met may be at least about 90% met, at least about 95% met, at least about 99% met, or even at least about 100% met.

As used herein, relational terms, such as “first,” “second,” “top,” “bottom,” etc., are generally used for clarity and convenience in understanding the disclosure and accompanying drawings and do not connote or depend on any specific preference, orientation, or order, except where the context clearly indicates otherwise.

As used herein, the term “and/or” means and includes any and all combinations of one or more of the associated listed items.

As used herein, the terms “vertical” and “lateral” refer to the orientations as depicted in the figures.

Nuclear energy production devices may generate substantial amounts of radiation and heat. The control systems for control drums associated with the nuclear energy production devices may be designed to withstand the radiation and heat generated by the nuclear energy production devices. As with most control systems, maintenance may be required to be performed on the control systems. Thus, it may be desirable to design the control system for the control drums in a way that maintenance personnel may be able to access and/or remove the control system without being exposed to large amounts of radiation and/or heat.

The control systems for the control drums may also be configured to withstand several types of failure scenarios, such that the control system is configured to position the associated control drum in a shutdown position in the event of a failure. Therefore, control systems may include several different fail-safe elements configured to return the control drum to a shutdown position without the use of power or other energy provided outside of the control system.

Nuclear energy production devices are now being produced in smaller, more compact configurations, such as microreactors. Smaller nuclear reactors may not afford as much space for the control systems and shielding. Compact modular control systems may use less space than the control systems used in traditional nuclear energy production devices. Compact modular control systems may also enable larger capacity nuclear energy production devices to be reduced in size while maintaining substantially the same capacity by reducing the area used by the control system.

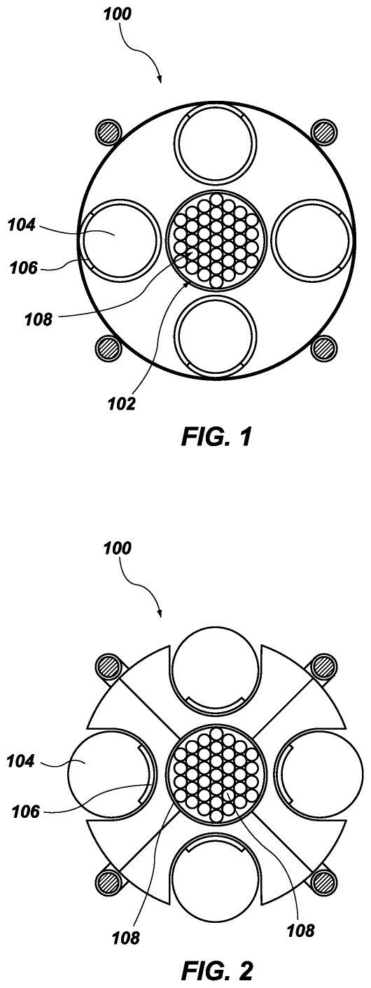

FIGS. 1 and 2 illustrate cross-sections of a reactor core 100 of a nuclear energy production device in two different control orientations. FIG. 1 illustrates the reactor core 100 with control drums 104 in a least limiting position. As illustrated in FIG. 1, the least limiting position of the control drum 104 may include positioning a portion of each of the control drums 104 including a neutron absorbing material 106 in a position the greatest distance from the fuel chamber 102. In this orientation, free neutrons within the fuel chamber 102 may be reflected from walls of the fuel chamber 102 or the reactor core 100 to continue to cause fission chain reactions in the fuel elements 108 within the fuel chamber 102.

FIG. 2 illustrates the reactor core 100 with the control drums 104 in a most limiting position. As illustrated in FIG. 2, the most limiting position of the control drums 104 may be positioning the portion of each of the control drums 104 including the neutron absorbing material 106 in a position proximate the fuel chamber 102. In this orientation the free neutrons within the fuel chamber 102 may be absorbed by the neutron absorbing material 106, such that the free neutrons are no longer available to cause fission reactions in the fuel elements 108.

In some embodiments, the control drums 104 may each be configured to include sufficient neutron absorbing material 106 that any one control drum 104 may absorb sufficient neutrons to stop chain reactions from occurring within the fuel chamber 102. In some embodiments, the control drums 104, may be configured such that any two control drums 104 may include sufficient neutron absorbing material 106 to stop the chain reactions within the fuel chamber 102.

In some embodiments, the control drums 104 may be configured to operate individually, such that each of the control drums 104 may rotate independent of the other control drums 104. In some embodiments, the control drums 104 may be configured to operate in pairs. For example, opposing control drums 104 (e.g., control drums on opposite sides of the reactor core 100) may be configured to rotate in substantially the same manner (e.g., both opposing control drums may be configured to be in a most limiting position or least limiting position at substantially the same time) and the pair may be configured to rotate substantially independent of the other pair(s) of control drums 104. In another embodiment, a pair of adjacent control drums 104 may be configured to rotate in substantially the same manner while being configured to rotate substantially independent of the other pair(s) of control drums 104. In some embodiments, all of the control drums 104 may be configured to rotate together in substantially the same manner.

The control drums 104 may be configured to fail to the position shown in FIG. 2. For example, in a fail-safe condition, such as a loss of power, loss of control signal, etc., the control drums 104 may each turn to the most limiting position configured to substantially stop the chain reactions in the fuel chamber 102.

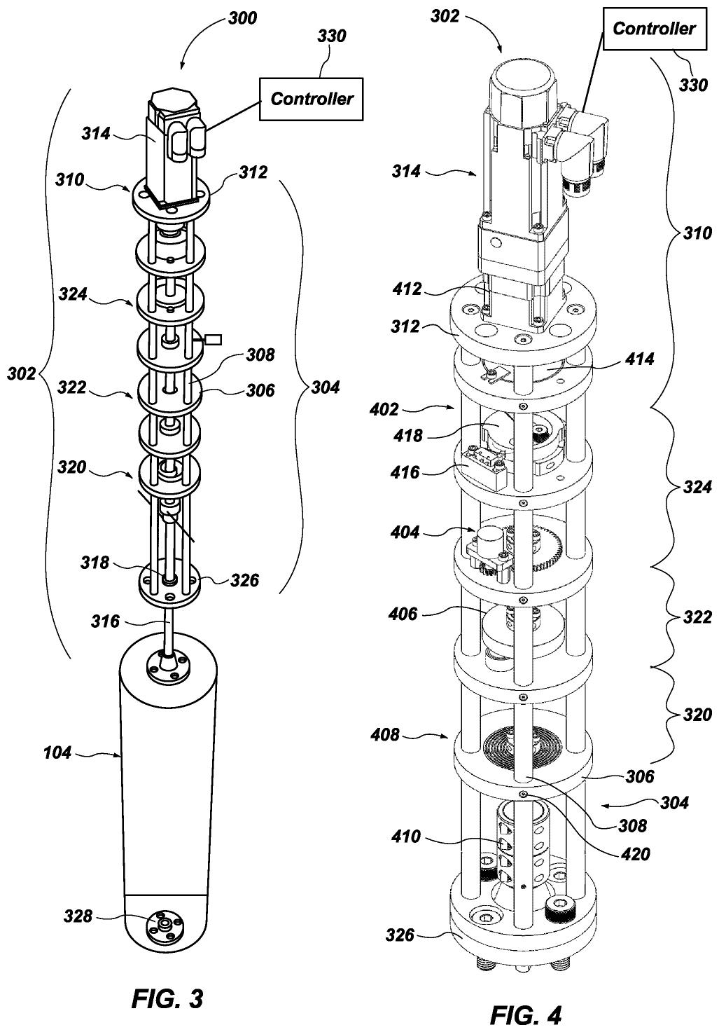

FIG. 3 illustrates a control drum assembly 300. The control drum assembly 300 may include a control drum 104 and a control system 302. The control system 302 may be modular, such that different elements may be added or removed based on the application. The modular control system 302 may include a cage assembly 304 including multiple platforms 306 connected through structural supports 308. The platforms 306 may support and/or separate different components of the control system 302.

A drive assembly 310 may be coupled to the control drum 104 and the associated components of the control system 302 through the cage assembly 304 by a drive shaft 316. The drive assembly 310 may include a motor 314, such as a stepper or servo motor, configured to rotate the control drum 104 to the desired position through the drive shaft 316. The drive assembly 310 may be coupled to the cage assembly 304 through a drive assembly platform 312. The drive assembly platform 312 may form a longitudinal end of the cage assembly 304, such that the structural supports 308 may be coupled to the drive assembly platform 312 and not extend through the drive assembly platform 312.

A base platform 326 may form an opposite longitudinal end of the cage assembly 304, where the cage assembly 304 is coupled to the reactor core 100. The structural supports 308 may extend between the base platform 326 and the drive assembly platform 312, such that the length of the structural supports 308 may define the distance between the drive assembly platform 312 and the base platform 326.

The additional platforms 306 may be arranged between the base platform 326 and the drive assembly platform 312. The additional platforms 306 may provide mounting positions for additional components of the control system 302. For example, the control system 302 may include a spring section 320, a damping section 322, and/or a sensor section 324. As described further below, each section 320, 322, and 324 may include one or more components, such as sensors, springs, damping mechanisms, shock absorbers, etc., that may each be mounted on a platform 306.

In some embodiments, the platforms 306 may provide additional shielding properties, such as heat shielding and/or radiation shielding. For example, the platforms 306 may be formed from a material with high density and other radiation shielding properties, such as lead. In some embodiments, the platforms 306 may be formed from a neutron reflective material, such as steel (e.g., stainless steel, SS 316, INCOLOY 800®, etc.), beryllium, beryllium metals, beryllium oxide, graphite, tungsten, carbide, gold, etc. In some embodiments, the platforms 306 may be formed from combinations of neutron reflective and high density materials. In some embodiments, different platforms 306 may be formed from different materials having different radiation shielding properties, such that in combination the materials may substantially inhibit the transfer of radiation along the length of the cage assembly 304.

Forming the platforms 306 from materials having heat shielding and/or radiation shielding properties may enable a user to access and/or work on the drive assembly 310 and/or other components of the control system 302 while limiting the user's exposure to radiation. Furthermore, forming the platforms 306 from materials having heat shielding and/or radiation shielding properties may protect more sensitive components of the control system 302 from the higher levels of radiation and heat during use and operation of the associated nuclear reactor.

In some embodiments, the structural supports 308 may be configured to dissipate heat from the associate nuclear reactor. For example, each of the structural supports 308 may be formed from a material having high thermal conductivity, such as metal materials. The length of the structural supports 308 may enable the structural supports 308 to act as heat dissipaters similar to fins on a fin-tube heat exchanger. The structural supports 308 may also substantially reduce the amount of heat that reaches the components on an opposite end of the cage assembly 304 from the associated nuclear reactor.

The control drum 104 may be supported on an end opposite the control system 302 by a drum support 328, as illustrated in FIG. 3. The drum support 328 may be configured to substantially reduce the weight of the control drum 104 being supported by the drive shaft 316 and the cage assembly 304. In some embodiments, the drum support 328 may provide a locating function to the control drum 104, such as by centering the control drum 104 over the drum support 328. For example, the drum support 328 may interface with a complementary feature on the control drum 104, such as a recess or aperture in the control drum 104.

FIG. 4 illustrates an enlarged view of the control system 302. As described above, the control system 302 may be constructed on a cage assembly 304 including structural supports 308 and platforms 306. The platforms 306 may be secured to the structural supports 308 through securing elements 420, such as set screws, pins, clamps, etc. The cage assembly 304 may include multiple structural supports 308, such as three or more structural supports 308, four or more structural supports 308 or six or more structural supports 308.

Each platform 306 may include apertures configured to receive the structural supports 308 and the securing elements 420 may be configured to couple the platform 306 to each of the structural supports 308. For example, if the securing elements 420 are set screws, the securing elements 420 may thread through the platform 306 proximate the structural supports 308, such that an end of the set screw may clamp into the structural supports 308, securing the platform 306 to the structural supports 308. In another example, the securing element 420 may be a pin. The platform 306 and the structural supports 308 may include holes, such that when the holes in the platform 306 and the structural supports 308 are aligned a pin may be inserted into the aligned holes securing the platform 306 to the structural supports 308. In another example, a screw or bolt may be configured to pass through both an outer portion of the platform 306 and the structural supports 308 before threading into an inner portion of the platform 306.

The platforms 306 may include different features or elements for performing different functions. The cage assembly 304 may enable the control system 302 to be modular, such that the platforms 306 may be changed, added, and/or positioned based on the application, making the control system 302 customizable for different applications. The cage assembly 304 may also enable the size of the control system 302 to be modular. For example, additional structural supports 308 may be added to increase the height of the control system 302, which may enable additional platforms 306 to be added and may enable more sensitive components to be placed a greater distance from the heat and radiation of the associated nuclear reactor.

The control system 302 may include a controller 330 configured to interface with one or more of the components of the control system 302. The controller 330 may be configured to send signals to components, such as the motor 314 and to receive signals from component, such as the sensors in the sensor section 324. In some embodiments, the controller 330 may be integrated into one or more of the components, such as the drive assembly 310. In other embodiments, the controller 330 may be located external to the cage assembly 304 and communicably coupled to the respective components.

The control system 302 may include a drive assembly 310 coupled to the drive assembly platform 312 on a first end of the cage assembly 304. The drive assembly 310 may include the motor 314. As described above, the motor 314 may be an electric motor, such as a stepper motor configured to control an angular position of the control drum 104 (FIG. 3). The motor 314 may be coupled to a gear box 412. The gear box 412 may be configured to multiply the force (e.g., torque) output by the motor 314 to the drive shaft 316 (FIG. 3). The gear box 412 may also reduce the amount of rotation (e.g., change in angle) transmitted to the drive shaft 316, which may allow for tighter control of the angular position of the control drum 104.

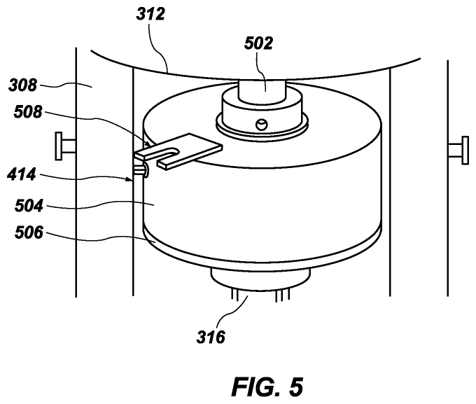

The motor 314 and the gear box 412 may be releasably coupled to the drive shaft 316 through a clutch 414. The clutch 414 may enable the motor 314 and gear box 412 to be de-coupled from the drive shaft 316 in the event of a system failure to allow one or more fail-safe features to take over control of the control drum 104 independent from the motor 314. The clutch 414 is described in further detail with respect to FIG. 5.

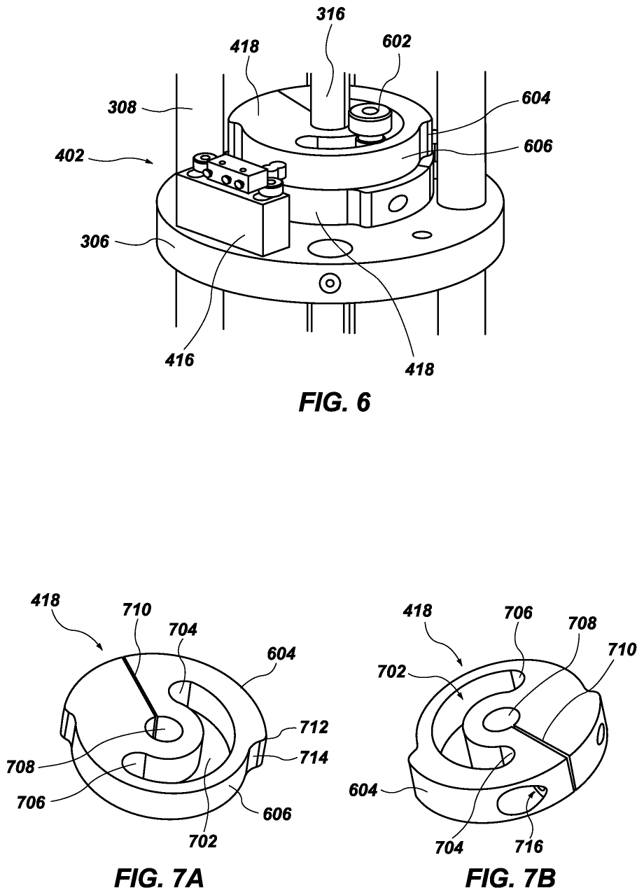

The control system 302 may also include a sensor section 324. The sensor section 324 may include one or more position sensors (e.g., rotational position sensors). For example, the sensor section 324 may include a platform 306 having a binary sensor 402 (e.g., an on/off sensor), such as end switches, limit switches, proximity switches, etc. The binary sensor 402 may include one or more switches 416 configured to interface with one or more triggers 418. The binary sensor 402 is described in further detail with respect to FIG. 6.

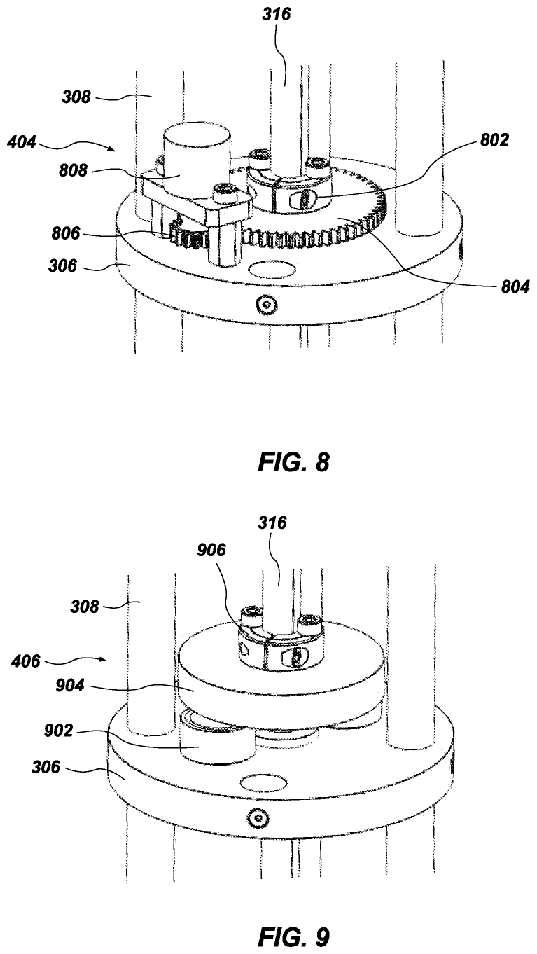

The sensor section 324 may include one or more platforms 306 including an analog sensor 404, such as a potentiometer, a reluctor wheel, etc. The analog sensor 404 may be configured to provide an analog output, such as an angle of rotation. The analog sensor 404 is described in further detail below with respect to FIG. 8.

The control system 302 may also include a damping section 322. The damping section 322 may include one or more damping devices 406 configured to reduce shock of a start or stop of the motor 314 or fail-safe device in the control system 302. Reducing the shock in the system may increase the life of the different components of the control system 302 and may enable improved control of the angular position of the control drum 104. The damping devices 406 are described in further detail with respect to FIG. 9.

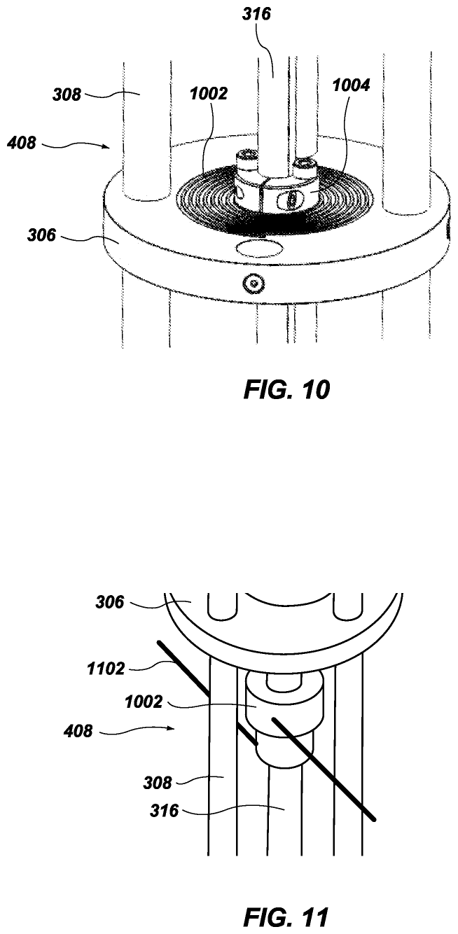

The control system 302 may also include a spring section 320. The spring section 320 may include a spring device 408 configured to load as the control system 302 rotates the control drum 104 (FIG. 3) away from the fail-safe or most limiting position, such that when the motor 314 is not driving the control drum 104, the spring device 408 may rotate the control drum 104 back to the fail-safe or most limiting position. The spring device 408 is described in further detail with respect to FIGS. 10 and 11.

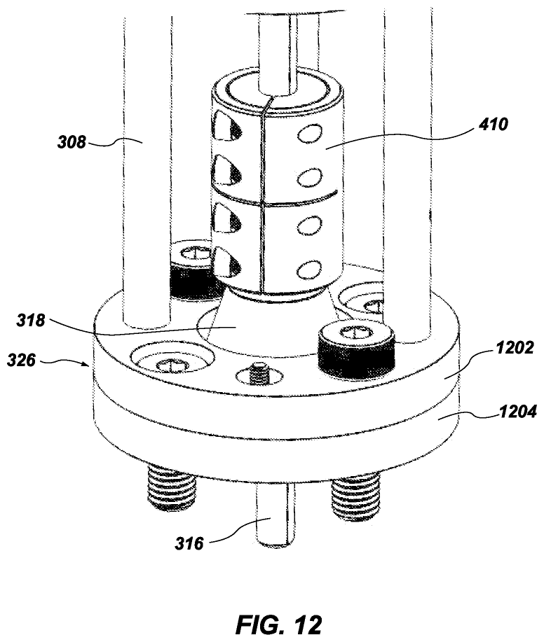

The cage assembly 304 may include a base platform 326 on an opposite end of the cage assembly 304 from the drive assembly platform 312. The base platform 326 may be configured to create an interface between the cage assembly 304 and the reactor core 100. The control system 302 may include one or more collars 410 configured to interface with elements of the base platform 326 to position the control system 302 relative to the reactor core 100. The base platform 326 and collars 410 are described in further detail below with respect to FIGS. 12-15.

FIG. 5 illustrates the clutch 414 with the associated platform 306 and one of the structural supports 308 removed to better view the clutch 414. The clutch 414 may include a wheel 504 and a clutch plate 506. The wheel 504 and the clutch plate 506 may be distinct parts configured to engage and disengage. When engaged, the wheel 504 and the clutch plate 506 may rotate at substantially the same speed. When disengaged, the wheel 504 and the clutch plate 506 may be configured to rotate independently from one another.

The wheel 504 may be coupled to a gear shaft 502 of the gear box 412 or the motor 314. The wheel 504 may be configured to be releasably coupled to the clutch plate 506. For example, the wheel 504 may include an electromagnet. The electromagnet may be formed from windings of wires configured to generate a magnetic field when a current is applied to the windings. The clutch plate 506 may be formed from a material that may be attracted to the magnetic field generated by the windings. When the electromagnet is powered, the clutch plate 506 may be coupled to the wheel 504 through the magnetic field, such that the clutch plate 506 may be coupled to and rotate with the wheel 504. Thus, when the gear shaft 502 is rotated by the motor 314, the gear shaft 502 may cause the wheel 504 to rotate and the magnetic field may cause the clutch plate 506 to rotate.

The clutch plate 506 may be coupled to the drive shaft 316. As described above, the drive shaft 316 may be coupled to the control drum 104. Thus, when the clutch plate 506 is rotated through the coupling with the wheel 504, the clutch plate 506 may cause the drive shaft 316 and the control drum 104 to rotate. When the electromagnet of the wheel 504 is no longer powered, the magnetic field generated by the electromagnet may cease. The lack of the magnetic field may allow the clutch plate 506 and the associated drive shaft 316 and control drum 104 to rotate independent of the wheel 504 and the associated motor 314, gear box 412, and gear shaft 502.

Disengaging the wheel 504 and the clutch plate 506 may enable safety features, such as fail-safe components, spring returns, etc., to rotate the drive shaft 316 and associated control drum 104 to the fail-safe or most limiting position. The wheel 504 may be configured to disengage the clutch plate 506 upon receiving an alarm, a power failure, an emergency trigger (e.g., emergency stop signal, failure alarm signal, safety stop signal, etc.).

The clutch 414 may be secured in place by a bracket 508. The bracket 508 may be configured to substantially prevent the clutch 414 from moving in a direction along a longitudinal axis of the drive shaft 316 away from the clutch plate 506. For example, the bracket 508 may be secured to the platform 306 as illustrated in FIG. 4. The bracket 508 may extend over the clutch 414, such that the bracket 508 may act as an axial stop, substantially preventing the clutch 414 from moving in an axial direction away from the clutch plate 506 while allowing the clutch 414 to rotate relative to the platform 306 and structural supports 308 of the cage assembly 304.

In some embodiments, the clutch 414 may be formed within a housing, such that the housing does not rotate relative to the cage assembly 304. In this case, the bracket 508 may be coupled to the housing, securing the housing both axially and rotationally to the platform 306. The wheel 504 of the clutch 414 may be disposed within the housing, and configured to rotate relative to the cage assembly 304 within the housing while the housing remains substantially stationary relative to the cage assembly 304.

FIG. 6 illustrates a binary sensor 402 secured to a platform 306 of the cage assembly 304. A binary sensor 402 may be configured to produce one or more on/off signals for a controller. Thus, a binary sensor 402 may operate as a switch. For example, the binary sensor 402 may operate as an end-switch, determining if the control drum 104 is in the most limiting position or in the least limiting position. In some embodiments, the binary sensor 402 may operate as a limit switch determining when the control drum 104 rotates past a predetermined position, such as a starting position (e.g., a position where the reactor may be allowed to approach a critical chain reaction point).

The binary sensor 402 may include a switch 416 and an associated trigger 418. The switch 416 may be secured to the platform 306 in a substantially stationary position. The trigger 418 may be configured to rotate with the drive shaft 316. The trigger 418 may be configured to activate the switch 416 when a portion of the trigger 418 passes the switch 416. For example, as illustrated in FIG. 6, the trigger 418 may be a cam and the switch 416 may include a follower. As the trigger 418 rotates, a peak 604 of the trigger 418 may activate the switch 416 by lifting the follower of the switch 416. A valley 606 of the trigger 418 may deactivate the switch 416 by lowering the follower of the switch 416.

In some embodiments, the switch 416 may be a proximity switch (e.g., contactless switch), such that the trigger 418 may include a component, such as a magnet, configured to activate the switch 416 when in proximity to the switch 416 without contacting the switch 416. For example, the trigger 418 may be substantially circular with a magnet disposed in the surface of the trigger 418 at a specified location. When the trigger 418 rotates such that the magnet is proximate the switch 416, the switch 416 may activate due to the proximity of the magnet. As the trigger 418 rotates and the distance between the magnet and the switch 416 increases, the switch 416 may deactivate.

As illustrated in FIG. 6, the binary sensor 402 may include multiple different triggers 418. For example, the triggers 418 may be stacked such that a first switch 416 is configured to interface with a first trigger 418 and a second switch 416 is configured to interface with a second trigger 418. In some embodiments, the first switch 416 and the second switch 416 may be stacked on each other. In some embodiments, the first switch 416 and the second switch 416 may be housed in a single component having two followers or proximity sensors in different vertical positions configured to interface with the respective first and second triggers 418. In other embodiments, the first switch 416 and the second switch 416 may be arranged in different positions about the outer portion of the platform 306.

In some embodiments, the binary sensor 402 may incorporate a hard stop 602. The hard stop 602 may be configured to interface with the trigger 418 to substantially stop movement of the drive shaft 316 and associated control drum 104 at a predetermined position. For example, the hard stop 602 may be configured to stop movement of the drive shaft 316 when the control drum 104 is at a safety position (e.g., the fail-safe or most limiting position), to prevent over-rotation of the control drum 104 (e.g., past the least limiting position), or to define an event position (e.g., starting position, high limit position, etc.).

In some embodiments, the hard stop 602 may be a pin or post extending from the platform 306 at a predetermined position. In other embodiments, the position of the hard stop 602 may be adjustable. For example, the hard stop 602 may be a threaded screw, as illustrated in FIG. 6. The position of the hard stop 602 may be changed by threading the hard stop 602 into different holes in the platform 306. In some cases, the platform 306 may include multiple different grooves arranged about the platform 306 and the hard stop 602 may be threaded into a clamp configured to be positioned within one of the grooves in the platform 306, wherein a position of the clamp in each groove is adjustable to enable refined adjustments to the position of the hard stop 602.

FIG. 7A and FIG. 7B illustrate different views of the trigger 418. The trigger 418 may include a groove 702 extending through the trigger 418 in an arc. The groove 702 may be configured to receive the hard stop 602. The groove 702 may include a first stop 704 and a second stop 706 each configured to interface with the hard stop 602 to stop rotation of the trigger 418. The trigger 418 may rotate between the first stop 704 and the second stop 706 with the hard stop 602 sliding within the groove 702 relative to the trigger 418.

The trigger 418 may include an aperture 708 configured to receive the drive shaft 316. The trigger 418 may also include a clamping split 710 and clamping hardware 716. The clamping split 710 may be configured to adjust a size of the aperture 708 with the clamping hardware 716. As the clamping hardware 716 is loosened, the size of the aperture 708 may increase, enabling the trigger 418 to be installed on and/or positioned relative to the drive shaft 316. When the clamping hardware 716 is tightened, the size of the aperture 708 may decrease. The decreasing size of the aperture 708 may clamp onto the drive shaft 316 and create an interference fit with the drive shaft 316 substantially securing the trigger 418 to the drive shaft 316. The clamping split 710 and the clamping hardware 716 may enable the position of the trigger 418 to be adjusted and/or customized based on the application. The trigger 418 being adjustable may enable multiple triggers 418 having substantially the same shape to be used in different positions to serve different purposes. For example, a first trigger in a first position may be configured to trigger a first end switch and a second trigger in a second position may be configured to trigger a second end switch or a limit switch.

As described above, the trigger 418 may be a cam configured to interface with a follower on the associated switch 416. The cam may have a peak 604 and a valley 606. Transition from the valley 606 to the peak 604 may include a valley transition 714 and a peak transition 712. The valley transition 714 and the peak transition 712 may be gradual transitions, such as a chamfer or a radius. The valley transition 714 and the peak transition 712 may be configured to enable the follower to transition from the valley 606 to the peak 604 and back without catching at the transition point.

FIG. 8 illustrates an analog sensor 404 secured to a platform 306 of the cage assembly 304. The analog sensor 404 may provide more refined position data than the binary sensor 402 described above. For example, the analog sensor 404 may provide angular position data between the end points. The analog sensor 404 may include a wheel 804 coupled to the drive shaft 316 with a coupler 802, such that the wheel 804 rotates with the drive shaft 316. The wheel 804 may interface with an input 806 of the analog sensor 404. For example, as illustrated in FIG. 8, the wheel 804 may be a toothed wheel, such as a gear or cog and the input 806 may be a complementary toothed wheel configured to mesh with the wheel 804. As the wheel 804 turns with the drive shaft 316, the input 806 may also turn. The sensor body 808 may house electronics configured to calculate an angular position of the control drum 104 based on the amount of rotation of the input 806.

In some embodiments, the input 806 may be another form of input, such as a hall-effect sensor. The wheel 804 may be a reluctor wheel including a set number of teeth or material changes. The input 806 may be configured to count the teeth or material changes of the wheel 804 as they pass. The sensor body 808 may include electronics configured to calculate an angular position of the control drum 104 based on the number of teeth or material changes that have passed the input 806.

FIG. 9 illustrates a damping device 406 secured to a platform 306 of the cage assembly 304. The damping device 406 may be configured to absorb shock in the system, such as from starts, stops, sudden changes in direction, disengagement from the clutch 414, etc. Absorbing the shock in the control system 302 may prolong the life of the components of the control system 302. Furthermore, tuning the damping device 406 may enable improved control of the position of the control drum 104, such as by reducing overshoot, reducing cycling, and increasing stability of the control system 302.

The damping device 406 may include a wheel 904 coupled to the drive shaft 316 through a coupler 906 and a resistance element 902 coupled to the platform 306. The resistance element 902 may be configured to interface with the wheel 904. For example, the wheel 904 may be formed from a ferromagnetic material and the resistance element 902 may be formed from a magnetic material configured to generate eddy currents in the wheel 904 through a magnetic field. The eddy currents may act to resist changes in movement of the drive shaft 316.

In some embodiments, the wheel 904 may include a plurality of magnets or coils of wire and the resistance element 902 may be formed from the other of a magnet or coil of wire, such that as the wheel 904 rotates relative to the resistance element 902, a current is generated in the coil or coils of wire and the generation of the current may act to generate a force opposing the motion of the wheel 904.

In some embodiments, the resistance element 902 may be an element configured to resist changes in movement of the drive shaft 316 through friction. For example, the resistance element 902 may be configured to contact the wheel 904, generating a force opposing motion of the wheel 904 through friction between the wheel 904 and the resistance element 902.

In some embodiments, the resistance element 902 may be a fluid resistance, such as air or hydraulic fluid. For example, the resistance element 902 may include a toothed gear interface with the wheel 904. The interface may cause an element to rotate within a tank of fluid. The motion of the element may be resisted by the fluid within the tank, such that the motion of the wheel 904 may be resisted by the toothed gear interface with the rotating element in the tank of fluid.

FIG. 10 illustrates a spring device 408 embedded in a platform 306 of the cage assembly 304. The spring device 408 may be configured to load a spring 1002 as the control drum 104 rotates away from the fail-safe or most limiting position and unload the spring 1002 as the control drum 104 returns to the fail-safe position. When the spring 1002 is loaded, the spring 1002 may apply an angular force to the drive shaft 316 in a direction toward the fail-safe position, such that if the clutch 414 is disengaged, the spring 1002 may cause the drive shaft 316 to rotate the control drum 104 to the fail-safe position.

The spring 1002 may be coupled to the drive shaft 316 through a coupler 1004. As illustrated in FIG. 10, the spring 1002 may be formed as part of the platform 306. For example, the spring 1002 may be formed by cutting a pattern into the platform 306 in the form of a torsional spring, such that the central portion of the platform 306 may be coupled to the drive shaft 316 and the outer portion of the platform 306 may be coupled to the structural supports 308. The spring 1002 formed into the platform 306 may enable the central portion of the platform 306 to rotate relative to the outer portion of the platform 306 while loading or unloading the spring 1002. In some embodiments, the spring 1002 may be a separate part disposed within an opening in the platform 306, coupling the platform 306 to the drive shaft 316.

In some embodiments, as illustrated in FIG. 11, the spring 1002 may be separate from the platform 306. For example, the spring 1002 may be coupled between the drive shaft 316 and the structural supports 308 of the cage assembly 304. As illustrated in FIG. 11, the spring 1002 may include arms 1102 extending from the spring 1002 to the structural supports 308. The spring 1002 may be coupled to the drive shaft 316, such that as the drive shaft 316 rotates relative to the cage assembly 304, the spring 1002 may load or unload through tension caused by the arms 1102 coupled to the structural supports 308.

FIG. 12 illustrates a view of the base of the cage assembly 304. The base platform 326 of the cage assembly 304 may include at least two platforms. The base platform 326 may include a cage base 1202 that may be coupled to the structural supports 308 and form part of the cage assembly 304. The base platform 326 may also include a mounting base 1204 configured to be coupled to the reactor. The base platform 326 may be configured to be separated, such that the mounting base 1204 may remain coupled to the reactor and the cage base 1202 may detach with the cage assembly 304. Detaching the cage assembly 304 from the mounting base 1204 may enable the control system 302 to be removed, such as for maintenance or replacement.

The control system 302 may include a collar 410 secured to the drive shaft 316 configured to position the control system 302 and/or control drum 104 in an axial direction. The collar 410 may be configured to act as a stop, such that the collar 410 may rest against a locating feature 318 of the reactor to stop the drive shaft 316 and the associated control drum 104 at a predetermined position.

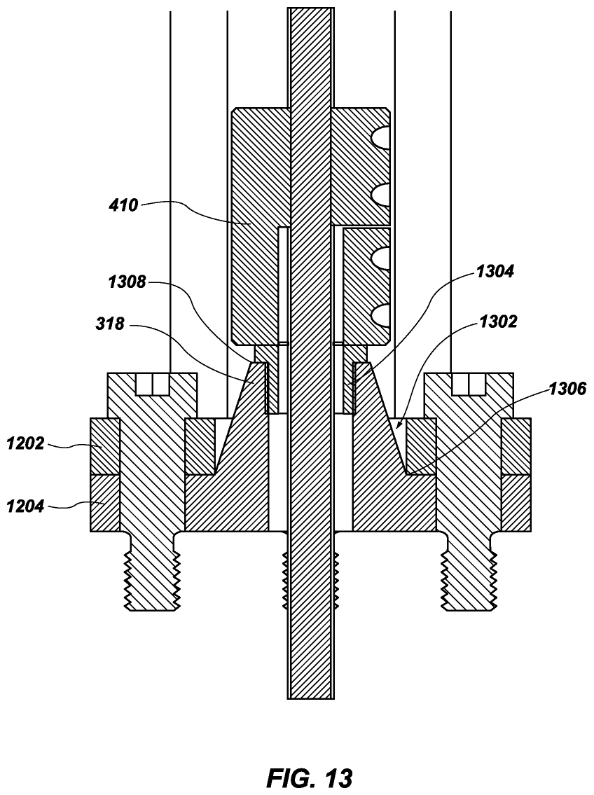

The locating feature 318 may extend from the mounting base 1204 as illustrated in further detail in FIG. 13. The locating feature 318 may be a tapered protrusion configured to locate the cage base 1202 relative to the mounting base 1204. For example, after the mounting base 1204 is installed on the reactor, the cage assembly 304 may be installed by lowering the cage assembly 304 over the mounting base 1204. The cage base 1202 may include an aperture 1302 having substantially the same diameter as a base 1306 of the locating feature 318. The aperture 1302 may be positioned over the tip 1308 of the locating feature 318 and the taper of the locating feature 318 may guide the cage base 1202 until the cage base 1202 comes to rest over the mounting base 1204 in a substantially coaxial position.

This may enable a user to remove and/or reinstall the cage assembly 304 after the reactor is installed, while allowing the user to remain at a distance. For example, the cage assembly 304 may be installed in a hole through additional layers of shielding. The additional layers of shielding may shield the user from radiation emitted by the reactor. As described above, the platforms 306 of the cage assembly 304 may also provide additional shielding properties, such that when the user is removing or replacing the cage assembly 304, the user may be separated from the reactor by several layers of radiation shielding.

As illustrated in FIG. 13, the collar 410 may include a nesting feature 1304 configured to be disposed within the locating feature 318 when the control system 302 is fully installed. The nesting feature 1304 may be configured to position the drive shaft 316 relative to the base platform 326, such as to prevent binding or other friction related failures that may occur in an un-centered drive shaft 316.

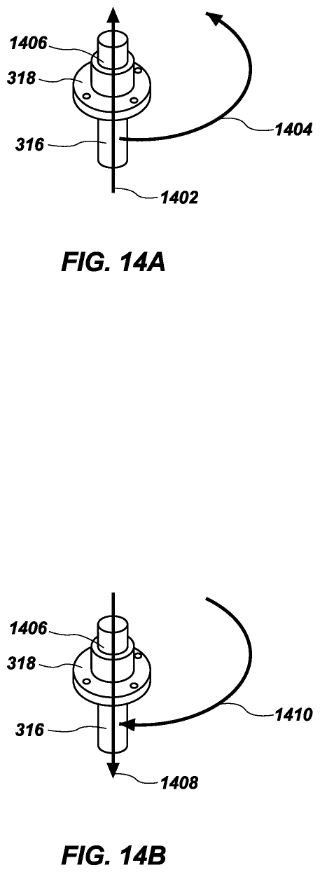

In some embodiments, the locating feature 318 may include a passive fail-safe return system as illustrated in FIGS. 14A and 14B. A passive fail-safe return system may be configured to use a constantly present force, such as gravity or axially compressed spring, to return the control drum 104 to the fail-safe or most limiting position.

The passive fail-safe return system may include a threaded interface 1406 between the locating feature 318 and the drive shaft 316. For example, the locating feature 318 and the nesting feature 1304 of the collar 410 may include complementary helical threads. The complementary helical threads may cause the control drum 104 to rise as indicated by the up arrow 1402 when the control system 302 rotates the control drum 104 away from the fail-safe or most limiting position in an upward rotation direction as indicated by the rotation arrow 1404. The complementary helical threads may cause the control drum 104 to lower as indicated by the down arrow 1408 when the control system 302 rotates the control drum 104 toward the fail-safe or most limiting position in a downward rotation direction as indicated by the rotation arrow 1410.

The total rotation of the drive shaft 316 and associated control drum 104 may be less than about 360°, such as about 270° or less or about 180° or less. The axial displacement of the control drum 104 may be less than about 5 in (127 mm), such as less than about 2 in (50.8 mm) or less than about 1 in (25.4 mm). The axial displacement and the size of the desired rotation may define a thread pitch of the complementary helical threads.

The thread pitch of the complementary helical threads may be configured such that a downward pull of gravity is sufficient to overcome the friction between the complementary threads. Thus, gravity pulling downward on the control drum 104 and the control system 302 may be sufficient to cause the control drum 104 to return to the fail-safe or most limiting position through the rotation caused by the complementary threads when the nesting feature 1304 is lowered relative to the locating feature 318.

As described above, the collar 410 may be configured to act as a stop, such that the collar 410 may rest against a locating feature 318 of the reactor to stop the drive shaft 316 and the associated control drum 104 at a predetermined position. Thus, the collar 410 may be positioned such that the collar 410 may rest against the locating feature 318 when the control drum 104 has rotated to the fail-safe or most limiting position stopping the downward movement and therefore stopping the rotation of the control drum 104.

In some embodiments, the passive fail-safe return system may be positioned in a different location. For example, the passive fail-safe return system may be disposed in one or more of the platforms 306 of the cage assembly 304. In some embodiments, the passive fail-safe return system may be positioned beneath the control drum 104, such as in the drum support 328 (FIG. 3), such that the control drum 104 may come to rest on top of the drum support 328 at the fail-safe position and may lift off the drum support 328 as the control drum 104 is rotated away from the fail-safe position.

Referring to FIGS. 1-14 together, while the control drum assembly 300 is depicted in a general vertical orientation, the disclosure is not so limited. Rather, one of ordinary skill in the art will readily recognize from the disclosure that the control drum assembly 300 could be utilized in a horizontal orientation or a tilted orientation.

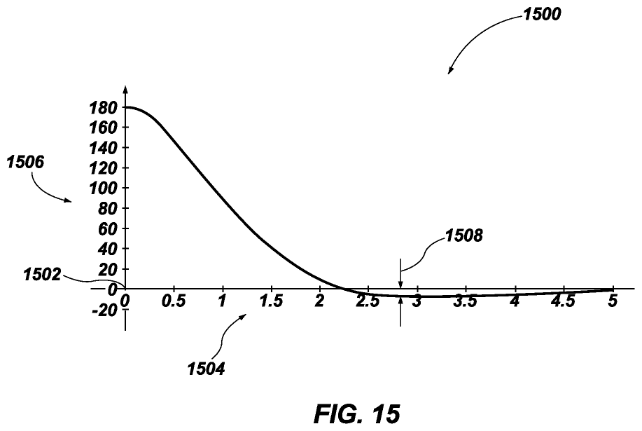

FIG. 15 illustrates a response curve 1500 of the control system 302 when the clutch 414 is disengaged and the fail-safe return systems drive the control drum 104 back to a fail-safe position 1502. The plot includes the angular displacement 1506 of the control drum 104 relative to the fail-safe position 1502 over the time 1504. The response curve 1500 may be represented by the following equation:

jθ″+cₜθ′+kₜθ=0

In the above formula “j” represents the polar moment of inertia of the control system 302 from the clutch plate 506 to the control drum 104 including the drive shaft 316 and all other components that are attached thereto; “cₜ” represents the damping effect provided by the damping devices 406 in the control system 302; “kₜ” represents the spring compliance of the spring devices 408 in the control system 302; and θ″, θ′, and θ represent the respective angular acceleration, angular velocity, and angular position of the control drum 104.

The damping devices 406 and spring devices 408 may be selected to minimize overshoot 1508 while still enabling the control drum 104 to reach the fail-safe position 1502 in a short period of time, such as the period of time that may be required for an emergency shutdown. For example, the control drum 104 may be configured to return to the fail-safe position 1502 from a maximum displacement in less than about 1 minute, such as less than about 30 seconds, or less than about 10 seconds, or less than about 1 second.

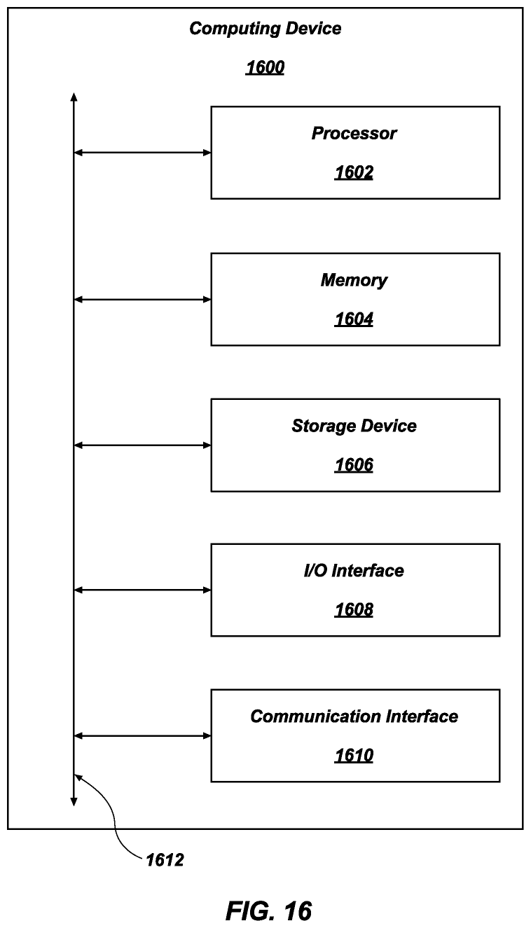

FIG. 16 is a block diagram of a controller 1600 according to one or more embodiments of the present disclosure. The controller 1600 may include the controller 330 described above. One will appreciate that one or more computing devices may implement the controller 1600. The controller 1600 can comprise a processor 1602, a memory 1604, a storage device 1606, an I/O interface 1608, and a communication interface 1610, which may be communicatively coupled by way of a communication infrastructure. While an example of a computing device is shown in FIG. 16, the components illustrated in FIG. 16 are not intended to be limiting. Additional or alternative components may be used in other embodiments. Furthermore, in certain embodiments, the controller 1600 can include fewer components than those shown in FIG. 16. Components of the controller 1600 shown in FIG. 16 will now be described in additional detail.

In one or more embodiments, the processor 1602 includes hardware for executing instructions, such as those making up a computer program. As an example and not by way of limitation, to execute instructions, the processor 1602 may retrieve (or fetch) the instructions from an internal register, an internal cache, the memory 1604, or the storage device 1606 and decode and execute them. In one or more embodiments, the processor 1602 may include one or more internal caches for data, instructions, or addresses. As an example and not by way of limitation, the processor 1602 may include one or more instruction caches, one or more data caches, and one or more translation lookaside buffers (“TLBs”). Instructions in the instruction caches may be copies of instructions in the memory 1604 or the storage device 1606.

The memory 1604 may be used for storing data, metadata, and programs for execution by the processor(s). The memory 1604 may include one or more of volatile and non-volatile memories, such as Random Access Memory (“RAM”), Read Only Memory (“ROM”), a solid state disk (“SSD”), Flash, Phase Change Memory (“PCM”), or other types of data storage. The memory 1604 may be internal or distributed memory.

The storage device 1606 includes storage for storing data or instructions. As an example and not by way of limitation, storage device 1606 can comprise a non-transitory storage medium described above. The storage device 1606 may include a hard disk drive (“HDD”), a floppy disk drive, flash memory, an optical disc, a magneto-optical disc, magnetic tape, or a Universal Serial Bus (“USB”) drive or a combination of two or more of these. The storage device 1606 may include removable or non-removable (or fixed) media, where appropriate. The storage device 1606 may be internal or external to the controller 1600. In one or more embodiments, the storage device 1606 is non-volatile, solid-state memory. In other embodiments, the storage device 1606 includes read-only memory (“ROM”). Where appropriate, this ROM may be mask programmed ROM, programmable ROM (“PROM”), erasable PROM (“EPROM”), electrically erasable PROM (“EEPROM”), electrically alterable ROM (“EAROM”), or flash memory or a combination of two or more of these.

The I/O interface 1608 allows a user to provide input to, receive output from, and otherwise transfer data to and receive data from controller 1600. The I/O interface 1608 may include a mouse, a keypad or a keyboard, a touch screen, a camera, an optical scanner, network interface, modem, other known I/O devices or a combination of such I/O interfaces. The I/O interface 1608 may include one or more devices for presenting output to a user, including, but not limited to, a graphics engine, a display (e.g., a display screen), one or more output drivers (e.g., display drivers), one or more audio speakers, and one or more audio drivers. In certain embodiments, the I/O interface 1608 is configured to provide graphical data to a display for presentation to a user. The graphical data may be representative of one or more graphical user interfaces and/or any other graphical content as may serve a particular implementation.

The communication interface 1610 can include hardware, software, or both. In any event, the communication interface 1610 can provide one or more interfaces for communication (such as, for example, packet-based communication) between the controller 1600 and one or more other computing devices or networks. As an example and not by way of limitation, the communication interface 1610 may include a network interface controller (“NIC”) or network adapter for communicating with an Ethernet or other wire-based network or a wireless MC (“WNIC”) or wireless adapter for communicating with a wireless network, such as a WI-FI.

Additionally or alternatively, the communication interface 1610 may facilitate communications with an ad hoc network, a personal area network (“PAN”), a local area network (“LAN”), a wide area network (“WAN”), a metropolitan area network (“MAN”), or one or more portions of the Internet or a combination of two or more of these. One or more portions of one or more of these networks may be wired or wireless. As an example, the communication interface 1610 may facilitate communications with a wireless PAN (“WPAN”) (such as, for example, a BLUETOOTH WPAN), a WI-FI network, a WI-MAX network, a cellular telephone network (such as, for example, a Global System for Mobile Communications (“GSM”) network), or other suitable wireless network or a combination thereof.

Additionally, the communication interface 1610 may facilitate communications various communication protocols. Examples of communication protocols that may be used include, but are not limited to, data transmission media, communications devices, Transmission Control Protocol (“TCP”), Internet Protocol (“IP”), File Transfer Protocol (“FTP”), Telnet, Hypertext Transfer Protocol (“HTTP”), Hypertext Transfer Protocol Secure (“HTTPS”), Session Initiation Protocol (“SIP”), Simple Object Access Protocol (“SOAP”), Extensible Mark-up Language (“XML”) and variations thereof, Simple Mail Transfer Protocol (“SMTP”), Real-Time Transport Protocol (“RTP”), User Datagram Protocol (“UDP”), Global System for Mobile Communications (“GSM”) technologies, Code Division Multiple Access (“CDMA”) technologies, Time Division Multiple Access (“TDMA”) technologies, Short Message Service (“SMS”), Multimedia Message Service (“MMS”), radio frequency (“RF”) signaling technologies, Long Term Evolution (“LTE”) technologies, wireless communication technologies, in-band and out-of-band signaling technologies, and other suitable communications networks and technologies.

The communication infrastructure 1612 may include hardware, software, or both that couples components of the controller 1600 to each other. As an example and not by way of limitation, the communication infrastructure 1612 may include an Accelerated Graphics Port (“AGP”) or other graphics bus, an Enhanced Industry Standard Architecture (“EISA”) bus, a front-side bus (“FSB”), a HYPERTRANSPORT (“HT”) interconnect, an Industry Standard Architecture (“ISA”) bus, an INFINIBAND interconnect, a low-pin-count (“LPC”) bus, a memory bus, a Micro Channel Architecture (“MCA”) bus, a Peripheral Component Interconnect (“PCI”) bus, a PCI-Express (“PCIe”) bus, a serial advanced technology attachment (“SATA”) bus, a Video Electronics Standards Association local (“VLB”) bus, or another suitable bus or a combination thereof.

Embodiments of the present disclosure may be modular control systems that may enable users to customize the arrangements, sizes, and/or inclusion of control elements based on the application. This may enable a similar control system to be used on multiple different reactors. Using substantially similar control system designs may reduce the cost of installing a new reactor as the design of the control system may be simplified by selecting components to place in the cage assembly of the control system rather than designing an entire control system.

A modular control system may also reduce the cost and time required for maintaining the control system. For example, rather than replacing an entire control system or sending the control system away to be rebuilt, the user may replace the specific module (i.e., platform) that has failed and reinstall the control system. Reducing the time required to perform maintenance on the control system may reduce downtime for the reactor. Reducing downtime may increase the reliability of the power provided by the reactor and may decrease the number of redundant systems or reactors needed for a plant or location to produce a consistent power output.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the present disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A control drum assembly comprising:
a control drum;
a control assembly coupled to the control drum through a drive shaft;
a cage assembly comprising one or more structural supports and one or more modular platforms coupled to the one or more structural supports, the one or more modular platforms configured to support one or more components of the control assembly.

2. The control drum assembly of claim 1, wherein the one or more components of the control assembly include at least one of a drive assembly, a position sensor, a damping device, and a spring device.

3. The control drum assembly of claim 1, wherein at least one of the one or more modular platforms comprises a material configured to reflect or absorb radiation.

4. The control drum assembly of claim 1, further comprising a releasable drive assembly coupled to a platform on an end of the cage assembly.

5. The control drum assembly of claim 4, wherein the releasable drive assembly comprises a releasable clutch coupling the releasable drive assembly to the drive shaft.

6. The control drum assembly of claim 5, wherein the releasable clutch comprises an electromagnetic clutch.

7. The control drum assembly of claim 1, further comprising a base platform on an end of the cage assembly.

8. The control drum assembly of claim 7, wherein the base platform comprises a cage base platform and a mounting platform, the mounting platform configured to be secured to a reactor core housing the control drum.

9. The control drum assembly of claim 8, wherein the cage base platform and the mounting platform are configured to be separated, such that the cage assembly is removable from the mounting platform and the reactor core.

10. A nuclear reactor comprising:
a core;
a control drum positioned within the core;
a control assembly coupled to the control drum through a drive shaft;
a cage assembly supporting the control assembly, the cage assembly comprising a base, the base including at least one platform configured to be coupled to a surface of the core and the at least one platform including a protrusion configured to locate the cage assembly relative to the core.

11. The nuclear reactor of claim 10, wherein the protrusion is tapered.

12. The nuclear reactor of claim 10, wherein the cage assembly comprises a second base platform configured to interface with the protrusion to locate the cage assembly.

13. The nuclear reactor of claim 12, wherein the second base platform includes a hole having a diameter that is substantially the same as a diameter of a base of the protrusion.

14. The nuclear reactor of claim 10, wherein the protrusion includes a threaded interface configured to interface with a complementary threaded interface coupled to the drive shaft.

15. The nuclear reactor of claim 14, wherein the complementary threaded interface comprises a collar coupled to the drive shaft.

16. The nuclear reactor of claim 14, wherein the threaded interface includes threads having a pitch sufficient to enable gravity to overcome friction between the threaded interface and the complementary threaded interface.

17. A method of returning a control drum to a fail-safe position, the method comprising:
releasing a control drum from an angular position that is substantially different from a fail-safe angular position;
lowering the control drum through a threaded interface, configured to cause the control drum to rotate as the control drum is lowered;
stopping the control drum through a stop collar coupled to the control drum, wherein the stop collar is configured to stop a downward motion of the control drum at a position when the control drum is in the fail-safe angular position.

18. The method of claim 17, further comprising accelerating the control drum in an angular direction with a spring device configured to unload in an angular direction toward the fail-safe angular position.

19. The method of claim 17, further comprising reducing start shock and stop shock on the control drum through a damping device.

20. The method of claim 17, wherein releasing the control drum comprises releasing a clutched connection between the control drum and a drive assembly.
